(19) United States
(12) Patent Application Publication
(10) Pub. No.: US 2003/0043279 A1
(43) Pub. Date: Mar. 6, 2003

(54) Video surveillance system

(75) Inventor: Anthony Alardin, Bedford, TX (US)

Correspondence Address: HAYNES AND BOONE, LLP, 1000 LOUISIANA, SUITE 4300, HOUSTON, TX, 77002, US

(73) Assignee: Alardin Development Corporation, Bedford, TX

(21) Appl. No.: 10/187,542

(22) Filed: Jul. 2, 2002

Related U.S. Application Data
(60) Provisional application No. 60/369,072, filed on Mar. 29, 2002.
(60) Provisional application No. 60/316,230, filed on Sep. 4, 2001.

(51) Int. Cl. H04N 5/232; H04N 7/18; H04N 5/225

(52) U.S. Cl. 348/211.3; 348/373; 348/211.2; 348/218.1; 348/211.9; 348/159

(57) ABSTRACT

A video surveillance system is described for providing on-site monitoring with off-site access to video images received during the on-site monitoring. The video surveillance system comprises a video camera operatively connected to a service hub. The service hub comprises a video server for converting the video images received by the video camera into wirelessly transmittable digital data and a means for transmitting the digital data across a wireless network.

### CROSS-REFERENCE TO RELATED APPLICATIONS

This application claims priority to the provisional applications filed on Sep. 4, 2001 (Serial No. 60/316,230) and Mar. 29, 2002 (Serial No. 60/369,072). These provisional applications are herein incorporated by reference for all legitimate purposes.

### BACKGROUND

This invention relates generally to a wireless video surveillance system for on-site real-time monitoring.

### BRIEF DESCRIPTION OF THE DRAWINGS

FIG. 1 is a flowchart depicting one exemplary process carried out according to aspects of the invention.

FIG. 2 is a partial-diagrammatic depiction of a video surveillance system with service hub and schematically depicted wireless network according to one embodiment of the present invention.

FIG. 3 is a partial-diagrammatic depiction of a solar-powered video surveillance system with service hub according to another embodiment of the present invention.

FIG. 4 is a diagrammatic depiction of the service hub of the video surveillance systems of FIGS. 2 and 3 according to one embodiment of the present invention.

FIG. 5 is a diagrammatic depiction of the service hub of the video surveillance systems of FIGS. 2 and 3 according to another embodiment of the present invention.

FIG. 6 is a perspective view of a portable video surveillance system with service hub according to another embodiment of the present invention.

FIG. 7 is a diagrammatic depiction of the service hub of the video surveillance system of FIG. 6.

FIG. 8 is a schematic diagram of an alternative embodiment of the video surveillance system.

### DETAILED DESCRIPTION

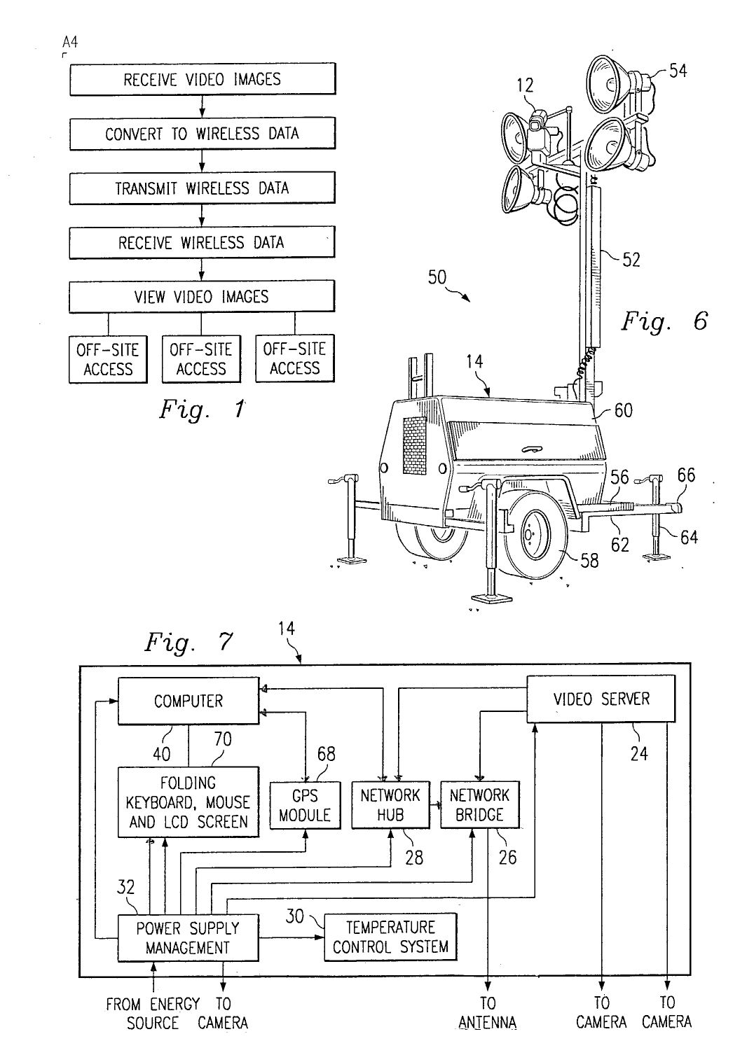

FIG. 1 depicts a process to be carried out by the video surveillance system according to certain aspects of the invention. It has been found to be desirable to use a video surveillance system to monitor valuable property located in remote or inaccessible areas. It is inconvenient and expensive to supplement such video surveillance systems with an on-site security guard. In many situations and at many locations, it may not be financially feasible to bear the costs of security measures that supplement a video surveillance system. Therefore, a solution provided by the present invention is a video surveillance system that can provide on-site monitoring while providing video images that may be easily accessed off-site, and preferably at a plurality of offsite locations linked by a communications network, such as the Internet.

Furthermore, it has been found that video surveillance systems often experience unforeseen disruptions during the transmission of video images. It has been discovered that such disruptions are especially problematic where video surveillance systems are provided at remote locations because there may be a significant loss of images during the time it takes to go on-site to resolve disruption problems. Therefore, the present invention also provides a video surveillance system that archives video images so that video images that are lost during transmission may be recovered at a later time.

An embodiment of the system and method of the present invention will be described in connection with a wireless video surveillance system (“video surveillance system”) for on-site real-time monitoring.

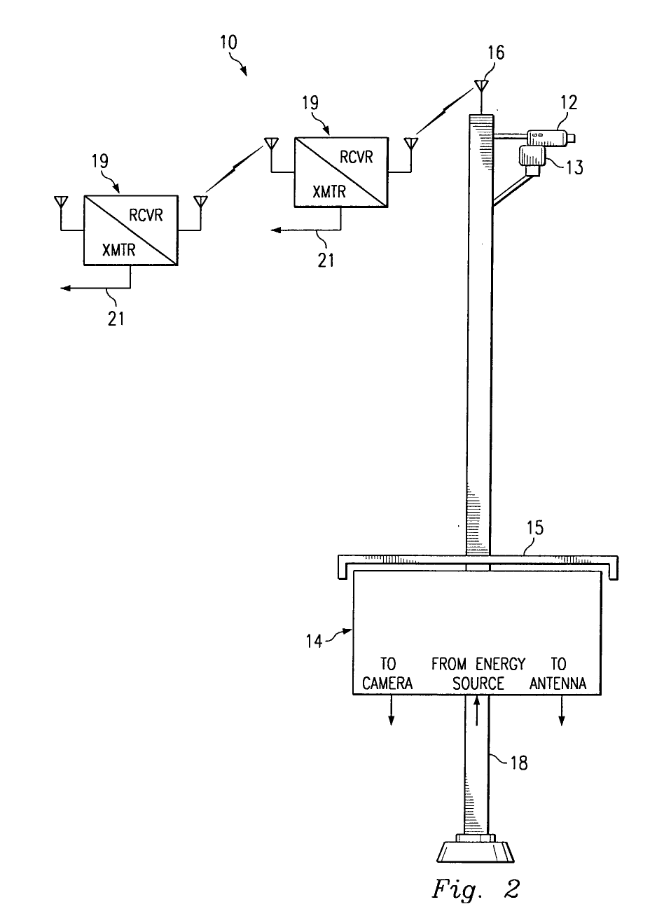

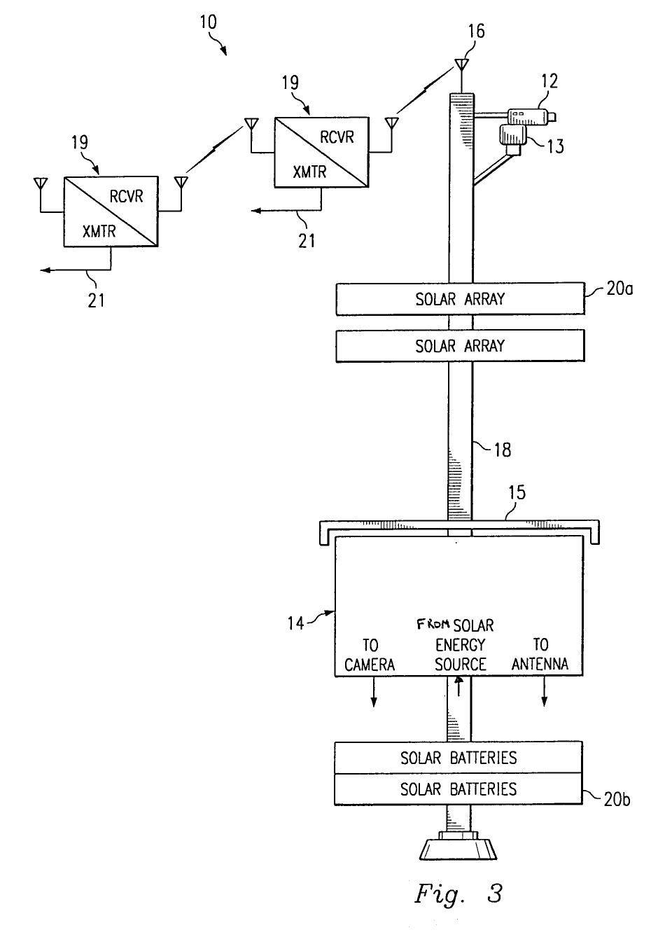

Referring to FIGS. 2 and 3, a video surveillance system 10 according to one embodiment of the present invention is depicted. The video surveillance system 10 comprises a video camera 12 for receiving video images for monitoring purposes at a remote location. The camera 12 may be fix-mounted or provided with pan-tilt-zoom functionality as with a remote-controlled pan-tilt-zoom device 13. Pan-tilt-zoom functionality increases the area that may be monitored by the camera 12, thereby reducing the number of cameras needed for the monitoring application. The camera 12 may be weather-proof to protect the camera from a variety of weather conditions at the site where video surveillance is desired.

Referring to FIG. 8, the video surveillance system 10 may optionally comprise three additional fixed video cameras 17 each covering a 90° field of view so that in cooperation with the video camera 12, the video surveillance system 10 may simultaneously monitor a 360° field of view. The fixed cameras 17 may be mounted lower than the camera 12 in order to not obstruct view. Furthermore, the fixed cameras 17 may be tilted to optimize the field of view. The camera 12 may then be utilized to focus in on any troublesome images captured by the fixed cameras 17. Such an arrangement will make optimal use of bandwidth while reducing video surveillance “blind spots”.

Referring back to FIGS. 2 and 3, the camera 12 may be a network camera for providing digital data representing received video images to a service hub 14 or it may advantageously be an analog camera operatively connected to the service hub 14 for converting the received video images into digital data. The data provided by the camera 12 is either in a digital format or is converted to a digital format that may be carried wirelessly over a predetermined wireless network such as an Ethernet network. A variety of wireless networking technologies including but not limited to licensed and unlicensed RF bands may be used without departing from certain inventive aspects of the present disclosure.

The video surveillance system 10, according to one embodiment, further comprises a shroud 15 to shield the service hub 14 from sunlight and adverse weather conditions, thereby protecting the service hub when the video surveillance system is located on-site.

The service hub 14 communicates with an antenna 16 for wirelessly transmitting the digital data over the wireless network to a communications network such as the Internet, a wireless LAN, a wireless WAN, or the like communications networks compatible with the digital image data being transmitted, and for receipt and review by an authorized user. The wireless network may comprise one transmitting antenna 16 and a receiver 19 that is then connected at 21 to the communication network (Internet, LAN, or WAN). Alternatively, in another embodiment, the wireless network may comprise a plurality of receivers 19 with the capability of retransmission for wireless transmission across long distances before connecting to the compatible communication network. The data may be coded or otherwise encrypted so that access is available only by the authorized user.

The video surveillance system 10 is depicted in FIG. 2 as mounted on a pole 18; however, it will be understood that the video surveillance system may be mounted on any surface, portable or fixed, provided the camera 12 has a desired view field and the service hub 14 is operatively connected to the camera.

Referring to FIG. 3, a solar array 20a may be mounted on the pole 18 for providing power to the video surveillance system 10. In addition, solar batteries 20b may be electrically connected to the solar array 20a and to the video surveillance system 10 to provide a means for storing solar energy generated by the solar array and for providing an energy means for supplying the stored energy to the video surveillance system. The utilization of solar energy in the present invention ensures the operability of the video surveillance system 10 in even the most remote locations. It has been found that a variety of energy means may be used to power the video surveillance system 10 such as a standard electrical power grid or a variety of alternative energy sources capable of providing required electrical energy to the video surveillance system without departing from other aspects of the invention.

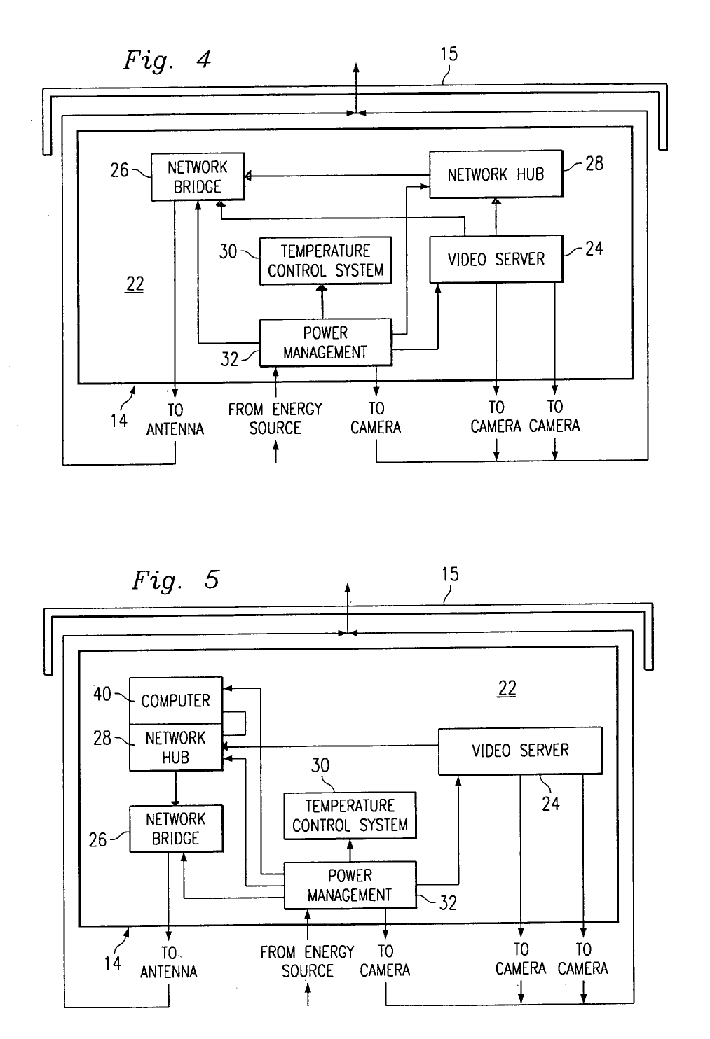

Referring to FIG. 4, the service hub 14 is shown in more detail. The service hub 14 is housed within an enclosure 22. Advantageously, enclosure 22 may be a NEMA approved all-weather enclosure. It has been found to be particularly advantageous to provide an enclosure 22 meeting the NEMA 4 IP 55 standards so that the video surveillance system 10 may be used in a wide variety of potentially adverse climatic conditions.

The service hub 14 comprises several components including a video server 24 operatively connected to the camera 12 for converting the video images received by the camera into wirelessly transmittable digital data. The video server 24 transfers the digital data to a network bridge 26 for transmitting the digital data over a predetermined wireless network via communication with the antenna 16. An optional network hub 28 may be provided in the service hub 14 for increasing the transfer speed of the digital data transmitted across the wireless network.

A temperature control system 30 such as a thermostat-operated fan/heater is further housed within the service hub 14 for maintaining the components of the service hub at an improved or optimal operating temperature compared to the ambient temperature. The temperature control system 30 controls the temperature within the service hub 14 by monitoring the temperature inside the service hub and maintaining the temperature within a predetermined temperature range via heating and cooling means.

The service hub 14 comprises a power management device 32 for transferring and distributing power from the energy means, such as the solar energy array 20a and solar batteries 20b, to the above-described components.

Referring to FIG. 5, an alternative embodiment of the present disclosure is provided wherein the service hub 14 further comprises a computer 40 for processing and storing the video images received by the camera 12 as digital data. The computer 40 comprises a conventional processing unit that contains processing instructions for implementing video surveillance management software for digitally recording images as a security measure and providing a variety of other security measures that may be pre-programmed into the software or additional installations that may be received on a variety of platforms. For example, motion detectors may be implemented into the video surveillance system 10 and the software may be programmed to detect and determine and to send a notification to an authorized user such as via an email alert. The computer 40 further archives received video images on a storage device within the computer 40 while additionally transmitting the digital data to the network bridge 26 for routing to the communication network.

The implementation of the computer 40 into the service hub 14 allows for digital storage of video images obtained by the camera 12. Thus, if a disruption were to occur to the wireless transmission of the digital data from the video surveillance system 10 to the communication network, the archived video images would provide a user with a means for subsequent viewing despite the disruption.

The components of the service hub 14 may advantageously all be supplied via commercial-off-the-shelf (COTS) technology. Thus, assembly and implementation of the components of the service hub 14 may be accomplished easily and cheaply.

In operation, the camera 12 monitors a location by receiving digital or analog video images. The video images are wirelessly or coaxially communicated to the video server 24, from the video server to the network bridge 26, and from the network bridge to the communications network where they may be accessed by an authorized user. Optionally, the video images may be communicated from the video server 24, to the network hub 28, and to the computer 40 before being transferred to the network bridge 26, and ultimately to the communications network.

Utilization of the service hub 14 advantageously allows for increased wireless transmission of the digital data across distances of up to 10-20 miles, thereby eliminating the need for a costly and inefficient wired infrastructure. As discussed previously, multiple receivers with the capability of retransmission may be used in the present invention to extend transmission distance. The long-distance wireless transmission allows for off-site access of the digital data developed by the on-site video surveillance system, thereby eliminating the need for on-site personnel to monitor the location and trouble-shoot video surveillance problems.

### Alternates and Equivalents

Referring to FIG. 6, a portable embodiment of the video surveillance system is generally given the reference numeral 50. As FIG. 6 is similar to FIGS. 2 and 3, identical components are given the same reference numerals. The portable video surveillance system 50 comprises the camera 12 mounted to a pole 52. Although the camera 12 is shown mounted near the distal end of the pole 52, it will be understood that the camera may be disposed at any location on the pole to provide a desired view. Furthermore, according to the disclosure above, the camera 12 may be fix-mounted or removably mounted to the pole 52. It will be further understood that the pole 52 may be adjustable to extend or contract.

The portable video surveillance system 50 may also comprise a lighting assembly 54 that may be disposed on the pole 52 adjacent to the camera 12 for providing illumination of the area being monitored. The lighting assembly 54 may be comprised of a metal-halide light system although any conventional lighting means is contemplated. Additional lights or lighting assemblies may be provided without departing from this aspect of the invention.

The bottom of the pole 52 connects to a base 56 to provide the video surveillance system 50 with portability. The base 56 may comprise one or more wheels 58 for providing the base with mobility. In the embodiment depicted in FIG. 6, the base 56 comprises a trailer including an attachment arm 62 and a connector 66, such as a trailer hitch. The connector 66 may couple the video surveillance system 50 to a conventional motive source, such as a truck (not depicted). Without departing from certain aspects of the invention, other modes of portability may also be used such as mounting on a self-powered vechicle (not depicted). The service hub 14 is supported by the base 56 and is located adjacent to the bottom of the pole 52.

The service hub 14 is advantageously housed in a weather-proof enclosure 60 that may be constructed of heavy-duty tubular steel. However, it is contemplated that the service hub 14 may be housed in enclosures composed of a variety of materials including NEMA approved all-weather enclosures. The enclosure 60 further comprises a conventional engine with generator (not depicted) for powering the lights. The enclosure 60 attaches to the base 56 to provide the portable video surveillance system 50 with sufficient weight and center of gravity to maintain stability. To further stabilize the portable video surveillance system 50, an attachment arm 62 extending from the base 56 may comprise an engageable crutch 64. The attachment arm 62 may further comprise a connector 66 for coupling the video surveillance system 50 to a conventional motive source, such as a truck (not depicted).

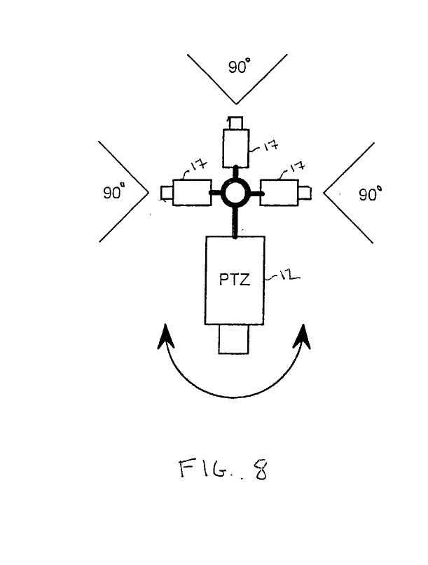

Referring to FIG. 7, a schematic component diagram of the service hub 14 of the portable video surveillance system 50 is shown with additional optional advantageous features. As FIG. 7 is similar to FIGS. 3 and 4, identical components are given the same reference numerals. An optional GPS module 68 operatively connects to the computer 40 for providing global positioning information that may be advantageous for confirming site location or for permitting tracking and recovery of devices should they be moved from an intended location.

An optional folding keyboard, mouse, and LCD screen unit 70 is further provided to allow a user on-site manipulation of the processing and storing functions of the computer 40.

Although only a few exemplary embodiments of this invention have been described in detail above, those skilled in the art will readily appreciate that many other modifications and combinations of the various advantageous features disclosed are possible without materially departing from the novel teachings and advantages of the invention. Accordingly, all such modifications and combinations are intended to be included within the scope of this invention as defined in the following claims.

What is claimed is:

1. An on-site video surveillance system, comprising:
a video camera for receiving video images; and
a service hub operatively connected to the video camera, the service hub comprising the components of:
a video server for converting the video images received by the video camera into wirelessly transmittable digital data; and
a means for wirelessly transmitting the digital data to a receiver connected to a communication network at an off-site location;
wherein the video images are accessible via the communication network at an off-site location.

2. The video surveillance system of claim 1 wherein the digital data is wirelessly transmittable across a distance of at least one mile.

3. The video surveillance system of claim 1 wherein the digital data is transmitted wirelessly across a wireless network of spaced apart receivers with retransmission capability prior to being connected to the communication network.

4. The video surveillance system of claim 1 wherein the service hub further comprises a computer for converting the video images into wirelessly transmittable digital data and for storing the digital data.

5. The video surveillance system of claim 4 wherein the service hub further comprises a network hub for separating the digital data from the video server and the computer before transmitting the digital data across the wireless network.

6. The video surveillance system of claim 1 wherein the service hub comprises a temperature control system for controlling the temperature within the service hub.

7. The video surveillance system of claim 1 wherein the service hub further comprises a power management device for distributing power to the components of the service hub.

8. The video surveillance system of claim 1 further comprising a shroud for protecting the service hub.

9. The video surveillance system of claim 1 wherein the service hub is housed within a NEMA 4 IP 55 enclosure.

10. The video surveillance system of claim 1 wherein the video camera utilizes pan-tilt-zoom technology via a pan-tilt-zoom control device.

11. The video surveillance system of claim 1 wherein the video surveillance system is powered by solar energy.

12. The video surveillance system of claim 1 wherein the video server is an Ethernet video server.

13. The video surveillance system of claim 1 wherein the means for wirelessly transmitting the digital data is an Ethernet bridge.

14. The video surveillance system of claim 5 wherein the network hub is an Ethernet hub.

15. The video surveillance system of claim 1 wherein the digital data is wirelessly transmitted across an Ethernet network.

16. A video surveillance system, comprising:
a video camera for receiving video images;
a service hub operatively connected to the video camera, the service hub comprising the components of:
an Ethernet video server for converting the video images received by the video camera into wirelessly transmittable digital data;
a computer for converting the video images received by the video camera into wirelessly transmittable digital data and for storing the digital data;
a wireless Ethernet bridge operatively connected to the Ethernet video server and the computer for wirelessly transmitting the digital data from the Ethernet video server and the computer across an Ethernet network;
an Ethernet hub for separating the data from the Ethernet video server and the computer before transmitting the data to the Ethernet bridge; and
at least one receiver of Ethernet data connected to a communication network selected from among the Internet, a LAN, or a WAN.

17. A portable video surveillance system, comprising:
a base comprising a service hub and a means for portability; and
a video camera for receiving video images, the video camera being operatively connected to the service hub;
wherein the service hub comprises the components of:
a video server for converting the video images received by the video camera into wirelessly transmittable digital data; and
a means for wirelessly transmitting the digital data across a wireless network.

18. The portable video surveillance system of claim 17 wherein the digital data is wirelessly transmittable across a distance of at least one mile.

19. The portable video surveillance system of claim 17 further comprising a pole operatively connected to the base, the video camera being mounted to the pole.

20. The portable video surveillance system of claim 17 wherein the service hub further comprises a computer for converting the video images into wirelessly transmittable digital data and for storing the digital data.

21. The portable video surveillance system of claim 20 wherein the service hub further comprises a network hub for separating the digital data from the video server and the computer before transmitting the digital data across the wireless network.

22. The portable video surveillance system of claim 17 wherein the service hub further comprises a temperature control system for controlling the temperature within the service hub.

23. The portable video surveillance system of claim 17 wherein the service hub further comprises a power management device for distributing power to the components of the service hub.

24. The portable video surveillance system of claim 17 further comprising a shroud for protecting the service hub.

25. The portable video surveillance system of claim 17 wherein the video camera utilizes pan-tilt-zoom technology via a pan-tilt-zoom control device.

26. The portable video surveillance system of claim 17 further comprising an attachment arm operatively connected to the base.

27. The portable video surveillance system of claim 26 wherein the attachment arm comprises a hitch for operatively connecting the video surveillance system to a motive source.

28. The portable video surveillance system of claim 17 further comprising an engageable crutch for providing support for the video surveillance system.

29. The video surveillance system of claim 17 wherein the video server is an Ethernet video server.

30. The video surveillance system of claim 17 wherein the means for wirelessly transmitting the digital data is an Ethernet bridge.

31. The video surveillance system of claim 17 wherein the network hub is an Ethernet hub.

32. The video surveillance system of claim 17 wherein the digital data is wirelessly transmitted across an Ethernet network.

33. A method of providing on-site video surveillance, comprising:
receiving video images via a video camera;
operatively connecting the video camera to a service hub;
converting the video images received by the video camera into wirelessly transmittable digital data in the service hub;
transmitting the digital data across a wireless network using a network bridge in the service hub; and
receiving the digital data transmission at an off-site location.
